(19) United States
(12) Patent Application Publication
(10) Pub. No.: US 2022/0121284 A1
(43) Pub. Date: Apr. 21, 2022

(54) WEARABLE MOTION CAPTURE DEVICE WITH HAPTIC FEEDBACK

(71) Applicant: Ian Walsh, Shorewood, WI (US)

(72) Inventor: Ian Walsh, Shorewood, WI (US)

(21) Appl. No.: 17/451,030

(22) Filed: Oct. 15, 2021

Related U.S. Application Data
(60) Provisional application No. 63/093,156, filed on Oct. 16, 2020.

(51) Int. Cl. G06F 3/01; G06F 3/0346; G06F 3/038

(52) U.S. Cl. CPC G06F 3/014; G06F 3/016; G06F 2203/0384; G06F 3/0346; G06F 3/038; G06F 3/017

(57) ABSTRACT

According to an aspect, a wearable motion capture device comprises a central controller, a plurality of controllers including a first controller and a second controller, where each of the plurality of controllers is configured to communicate with the central controller, and a plurality of sensor and feedback units. Each sensor and feedback unit includes at least one of a position sensor and a haptic element, where the position sensor is configured to capture positional data about a position of a body part of a user. The central controller includes a position calculator configured to compute a position based on the positional data and a wireless transmitter configured to transmit the computed position to a computing device over a network.

### CROSS-REFERENCE TO RELATED APPLICATION

This application claims priority to U.S. Provisional Patent Application No. 63/093,156, filed on Oct. 16, 2020, the disclosure of which is incorporated by reference herein in its entirety.

### FIELD OF THE DISCLOSURE

The present disclosure relates to a wearable motion capture device with haptic feedback.

### BACKGROUND

A motion capture device (or suit) with haptic feedback may be a wearable device that can capture and track the position of a user and provide haptic feedback. In some examples, motion capture devices may operate in conjunction with a virtual reality (VR) and/or augmented reality (AR) environment in which the device can sense the position of the user in the VR/AR environment and provide haptic feedback as the user interfaces with the VR/AR environment. However, some conventional motion capture devices with haptic feedback are relatively bulky (and heavy) and involve relatively slow processing times to accurately compute the position of the user in real-time.

### SUMMARY

The present disclosure provides an improved motion capture device (e.g., suit) with haptic feedback that is relatively lightweight and can quickly and accurately compute and track the position of the user (e.g., a three-dimensional (3D) position of the user) in real-time while providing haptic feedback. The wearable device may include a central controller (e.g., a master controller) configured to communicate with one or more of a plurality of controllers (e.g., slave controllers), where each controller communicates with a plurality of sensor and feedback units (also referred to as “unit”). In some examples, the wearable device is modular (e.g., fully modular) in the sense that additional units can be easily integrated within the device to capture the motion and/or provide haptic feedback to other body parts.

Each unit may include one or more positional sensors and one or more haptic elements. The positional sensors are configured to obtain positional data (e.g., rotational data) of the user's body parts. The haptic elements are configured to provide haptic feedback (e.g., when the user comes into contact with a virtual object). In some examples, the haptic elements include vibration elements that are configured to vibrate when stimulated. However, the haptic elements may include any type of haptic feedback mechanism including electric pulses, pressure, and/or any mechanism that provides the feeling of touch.

Each unit routes the positional data back to its respective slave controller, and the slave controller routes the positional data back to the central controller. In some examples, the units are positioned on different parts of the user's body. In some examples, the units are positioned on the fingers of the user, which can capture the rotational motion of the fingers. However, the units may be positioned on any part of the body such as the hands, waist, chest, back, legs, feet, etc. to capture additional motion of the user. In some examples, the central controller uses the positional data to compute a position (e.g., a 3D position) of the user. In some examples, the central controller is configured to transmit the positional data, over a network, to an external device, and the external device computes the position of the user. Also, the central controller may receive haptic feedback signals from the external device (where the external device is executing a VR/AR application), which is then provided to its respective controller, and then to its respective units to provide haptic feedback (by the haptic elements) while the user interacts within the VR/AR environment. In some examples, the central controller includes (or is associated with) an artificial intelligence (AI) controller configured to execute a neural network to estimate or compute a type of gesture of a user. In some examples, the external device receives the position and/or positional data, and the external device can estimate or compute a type of gesture of the user. In some examples, the motion capture device includes an intelligent battery management system whereby individual cells are continuously (e.g., periodically) monitored by one or more fuel gauges (e.g., battery fuel gauges). This system may transmit real-time battery usage and other metadata to the central controller, which can optimize device performance time and improve overall user experience. When charging, the device may be able to track battery performance statistics. Using historical data, the battery's end of life can be computed and/or estimated.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1A illustrates a wearable motion capture device with haptic feedback according to an aspect.

FIG. 1B illustrates a sensor and feedback unit of the wearable motion capture device according to an aspect.

FIG. 1C illustrates a position sensor of the sensor and feedback unit according to an aspect.

FIG. 1D illustrates a wearable motion capture device being worn on portions of a user according to an aspect.

FIG. 1E illustrates a serpentine wiring format for wired connections between components on the wearable motion capture device according to an aspect.

FIG. 1F illustrates a wiring topology for wired connections between components on the wearable motion capture device according to an aspect.

FIG. 2 illustrates a power management module of the wearable motion capture device according to an aspect.

FIG. 3A illustrates an example implementation of a portion of a wearable motion capture device with haptic feedback according to an aspect.

FIG. 3B illustrates examples of controllers and sensor and feedback units of the wearable motion capture device according to an aspect.

FIG. 4 illustrates a data transfer protocol according to an aspect.

FIG. 5 illustrates an output protocol according to an aspect.

FIG. 6 illustrates a motion fusion engine according to an aspect.

FIG. 7 illustrates a flowchart depicting example operations of a wearable motion capture device according to an aspect.

The components in the drawings are not necessarily to scale relative to each other. Like reference numerals designate corresponding parts throughout the several views.

### DETAILED DESCRIPTION

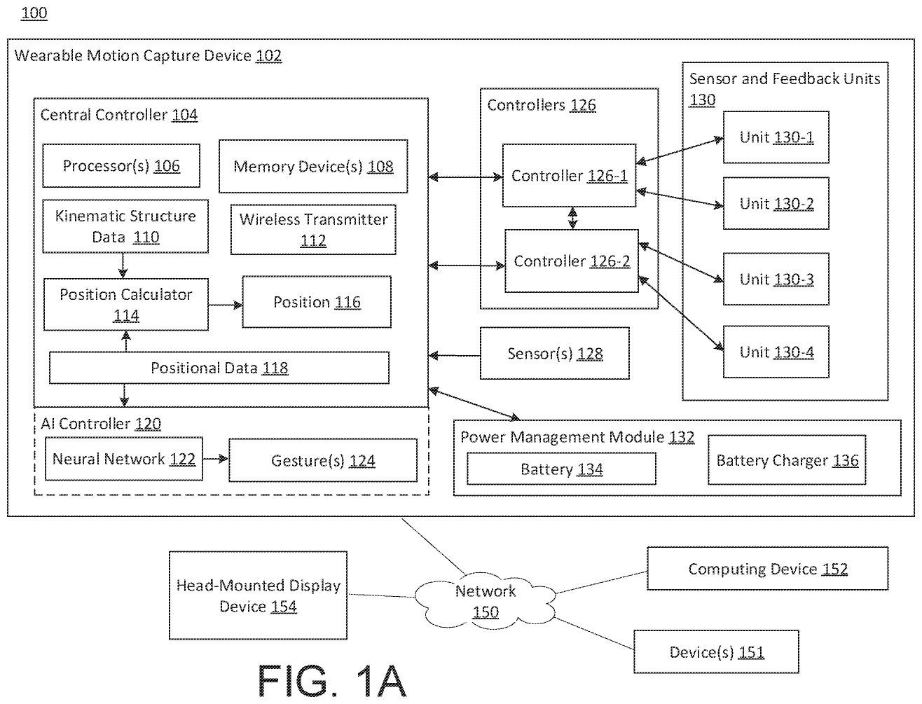

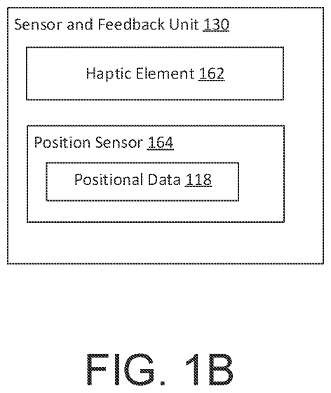

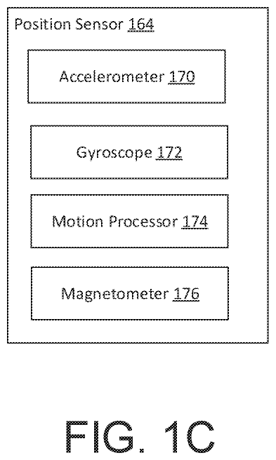

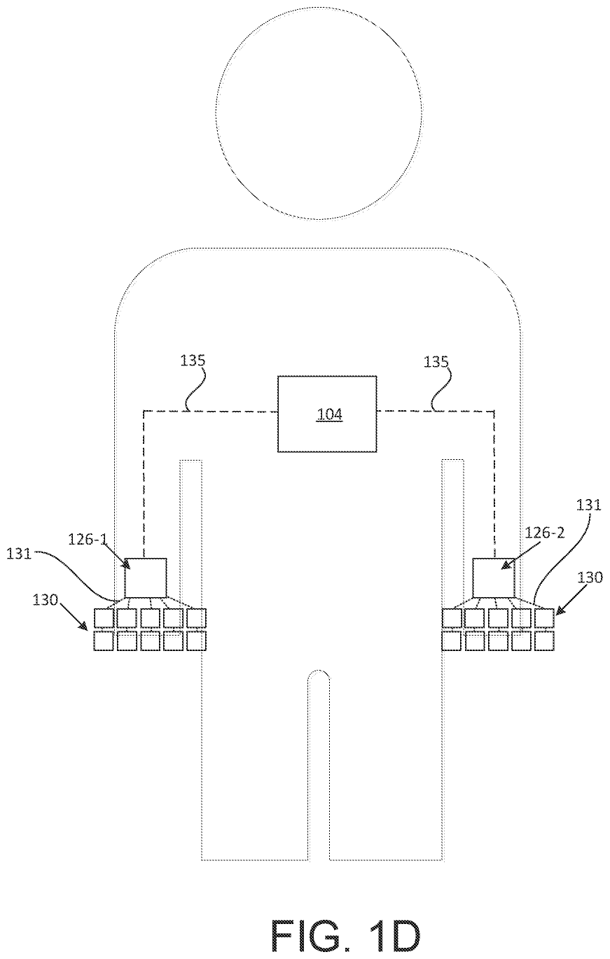

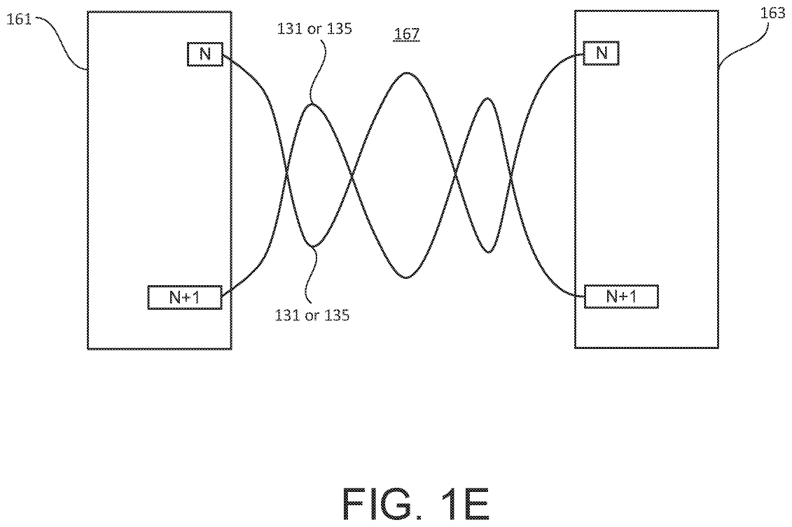

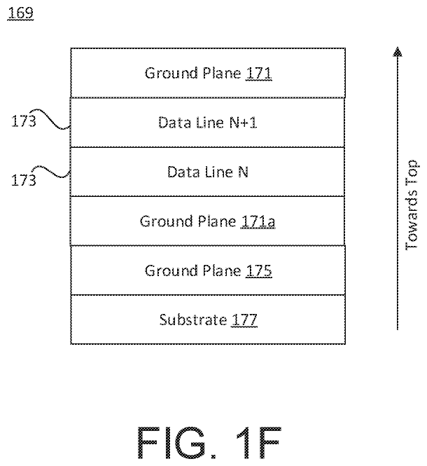

FIGS. 1A through 1F illustrate a system 100 having a wearable motion capture device 102 with haptic feedback that is configured to communicate with a computing device 152 (e.g., a laptop, desktop, smartphone, tablet, server computer, etc.) and/or a head-mounted display device 154 over a network 150 according to an aspect.

In some examples, the wearable motion capture device 102 may communicate (e.g., wirelessly communicate) with one or more devices 151 over the network 150. The devices 151 may include a wide range of network-enabled devices such as image sensors (e.g., cameras, depth sensors, etc.), biometric sensors (e.g., heart rate monitor, pulse oximeter, face/iris recognition sensor, speech recognition, etc.), temperature sensors, pressure sensors, IR or ultrasonic sensors, smoke and gas sensors, smart devices (e.g., thermostats, switches, light switches, home speakers, home appliances, industrial machinery, etc.), network-enabled wearable devices, and/or other devices such as laptops, tablets, desktops, gaming consoles, headphones, access points, printers, scanners, or copiers, etc.

In some examples, the wearable motion capture device 102 may receive data from one or more of the devices 151, where the received data may trigger one or more haptic elements 162. The data may be measured sensor data or data computed by the device 151 itself. For example, if a device 151 is a smart appliance (e.g., oven), the wearable motion capture device 102 may receive information that a timer on the smart appliance has expired, which may cause the wearable motion capture device 102 to trigger one or more haptic elements 162 to notify the user that the timer has expired. In some examples, a user may be able to configure certain conditions that trigger one or more haptic elements 162, which haptic elements 162 are triggered (e.g., one or more haptic elements 162 on the right or left hand or both, on a particular finger, on the chest, etc.), and/or a specific haptic feedback pattern (e.g., activate/deactivate the haptic elements 162 in a particular pattern). For example, if one of the devices 151 is a smart doorbell, the motion capture device 102 may be configured to trigger the haptic elements 162 on the right hand according to a specific pattern when the doorbell is pressed. If one of the devices 151 is a temperature sensor, the motion capture device 102 may trigger the haptic elements 162 on the left hand according to a different pattern when the temperature exceeds a threshold amount.

In some examples, the wearable motion capture device 102 may be used to control one or more devices 151. For example, the wearable motion capture device 102 (and, in some examples, in conjunction with the computing device 152) may detect that movement of a user corresponds to a gesture that relates to a command, and then transmit a command signal to the device 151 to instruct the device 151 to execute a particular function. For example, a particular hand (or arm) gesture may indicate to deactivate a light switch, answer a phone call, render a menu (having controllable options) on an interface of a head-mounted display device 154, etc. The wearable motion capture device 102 may also be used to control vehicles like UAVs (unmanned aerial vehicle), planes, boats, etc., using a series of gestures and/or other control points that represent certain vehicle actions (e.g. turning to the left).

The wearable motion capture device 102 is placed or worn on a user. In some examples, the wearable motion capture device 102 is considered a motion capture and haptic feedback suit. As further described in detail below, the wearable motion capture device 102 may track the motion and/or compute the position (e.g., a 3D position) of the user, as well as provide haptic feedback as the user interacts within an VR/AR environment. In some examples, besides tracking the motion/position of the user (and providing haptic feedback), the wearable motion capture device 102 may obtain other sensor data such as the temperature, heat rate, and/or other biometrics of the user via one or more sensor(s) 128. In addition, the wearable motion capture device 102 may provide other feedback (besides haptic feedback) such as sound and/or lighting.

The wearable motion capture device 102 includes a central controller 104, a plurality of controllers 126, a plurality of sensor and feedback units 130, and a power management module 132. The central controller 104, the controllers 126, the feedback units 130, and/or the power management module 132 may be coupled to one or more wearable pieces of material. In some examples, the central controller 104, the controllers 126, and the sensor and feedback units 130 are embedded into an article of clothing such as a suit or undergarment, which may include one continuous (integral) piece of material or multiple pieces of materials that are connected together.

In some examples, the central controller 104 is considered a master controller, and each of the controllers 126 are considered slave controllers. In some examples, the central controller 104 is coupled to (or embedded into) a piece of material (e.g., fabric) that is attached to a part of the user's body. In some examples, as shown in FIG. 1D, the central controller 104 is coupled to an area proximate to the user's chest. As shown in FIGS. 1A and 1D, the central controller 104 is connected to each controller 126 via a communication line 135 (or multiple communication lines 135). In some examples, the communication line 135 is a wired (conductive) communication line. In some examples, the communication line 135 represents a wireless communication link. Data (e.g., haptic feedback commands, positional data 118) may be exchanged between the central controller 104 and the controllers 126 via the communication line 135.

As shown in FIG. 1A, the controllers 126 may include a first controller 126-1 and a second controller 126-2. Although FIG. 1A illustrates two controllers 126, the embodiments may include any number of controllers 126 such as one controller 126, three controllers 126, four controllers 126, or any number greater than four controllers 126. Each controller 126 is connected to one or more sensor and feedback units 130. In other words, each controller 126 is provided for a separate group of sensor and feedback units 130 (where a group can include one or more units). In some examples, each controller 126 is connected to the sensor and feedback units 130 via a communication line 131 (or multiple communication lines 131). In some examples, the communication line 131 is a wired (conductive) communication line. In some examples, the communication line 131 represents a wireless communication link.

As shown in FIG. 1A, the first controller 126-1 is connected to a sensor and feedback unit 130-1 and a sensor and feedback unit 130-2, and the second controller 126-2 is connected to a sensor and feedback unit 130-3 and a sensor and feedback unit 130-4. Although FIG. 1A illustrates the first and second controllers 126-1, 126-2 being connected to two sensor and feedback units 130, a respective controller 126 may be connected to any number of sensor and feedback units 130.

In some examples, a first group of sensor and feedback units 130 is provided on a first body part of the user. In some examples, the first body part is the right hand of the user, as shown in FIG. 1D. For example, the first group of sensor and feedback units 130 may be attached to a glove or other type of other article (or material), which is placed over the right hand. In some examples, two sensor and feedback units 130 may be provided on each of the fingers of the right hand. In some examples, a controller 126 (e.g., the first controller 126-1) is provided on a location on the user that is proximate to the first group of sensor and feedback units 130. For example, the controller 126 may be provided on the wrist of the right hand and/or the right arm.

In some examples, a second group of sensor and feedback units 130 is provided on a second body part of the user. In some examples, the second body part is the left hand of the user, as shown in FIG. 1D. For example, the second group of sensor and feedback units 130 may be attached to a glove or other type of article (or material), which is placed over the left hand. In some examples, two sensor and feedback units 130 may be provided on each of the fingers of the left hand. In some examples, a controller 126 (e.g., the second controller 126-2) is provided on a location on the user that is proximate to the first group of sensor and feedback units 130.

In some examples, as shown in FIG. 1E, the communication lines 135 and/or the communication lines 131 may include a serpentine wiring format 167. Component 161 may represent one of the central controller 104, the controller 126, or the sensor and feedback units 130, and component 163 may represent one of the central controller 104, the controller 126, or the sensor and feedback units 130. As shown in FIG. 1E, each communication line 131 or 135 may define portions having relatively large angles (e.g., equal to or greater than 35 degrees, equal to or greater than 70 degrees, equal to or greater than 90 degrees). In some examples, one or more of the communication lines 131 or 135 may intercept each other. Conventional wearable devices may be limited by uncomfortable, bulky, and/or high resistance wiring that is susceptible to electrical and magnetic interference. The use of the serpentine wiring format 167 (as shown in FIG. 1E) may reduce some of these issues. For example, coupling inductance (and, therefore, inductive spike noise) can be removed by the large angles between data wires (e.g., high speed data wires).

In some examples, as shown in FIG. 1F, the communication lines 131 or 135 may define or be included as part of a wiring topology 169. For example, the wired connections between the central controller 104 and the controllers 126 and/or between the controllers 126 and the sensor and feedback units 130 may include a ground plane 171 (e.g., a flexible ground trace), one or a plurality of data lines 173 (e.g., data line N, data line N+1), another ground plane 171a (e.g., a flexible ground trace), where the ground plane 171a is coupled to a substrate 177. The substrate 177 may include portions of the suit material. In some examples, environmental electromagnetic noise can be removed or lessened by placing the ground plane 171 over the data lines 173.

As shown in FIG. 1B, the sensor and feedback unit 130 may include one or more haptic elements 162. The haptic element(s) 162 are configured to provide haptic feedback when activated by a haptic feedback command generated by the central controller 104. The haptic element(s) 162 may refer to any type of element that can create an experience of touch or simulate sensory interaction by applying forces, vibrations, motions, and/or temperatures to the user. In some examples, the haptic element(s) 162 include vibration member(s) that vibrate when activated. In some examples, the haptic element(s) 162 include electrical member(s) that provide electrical stimulation when activated. In some examples, the haptic element(s) 162 include mechanical or movable members that move when activated. In some examples, the haptic element(s) 162 include electrical members that create an increase or decrease of temperature. Also, the sensor feedback unit 130 may include one or more position sensors 164 that obtain positional data 118 about the body part that is attached to the sensor feedback unit 130. The positional data 118 may include position, orientation, linear velocity, angular velocity, linear acceleration, and/or angular acceleration. In some examples, as shown in FIG. 1C, the position sensor 164 includes an accelerometer 170, a gyroscope 172, a motion processor 174, and a magnetometer 176. In some examples, the accelerometer 170, the gyroscope 172, the motion processor 174, and the magnetometer 176, collectively, are configured to derive the positional data 118.

Each sensor feedback unit 130 is configured to obtain positional data 118, which is then routed to its respective controller 126. For example, the first controller 126-1 receives the positional data 118 from the sensor and feedback unit 130-1 and the sensor and feedback unit 130-2 via the communication lines 131, and the second controller 126-2 receives the positional data 118 from the sensor and feedback unit 130-3 and the sensor and feedback unit 130-4 via the communication lines 131. Then, the central controller 104 receives the positional data 118 from the controllers 126 via the communication line 135.

The central controller 104 includes one or more processor(s) 106 and one or more memory device(s) 108. The processor(s) 106 may be formed in a substrate configured to execute one or more machine executable instructions or pieces of software, firmware, or a combination thereof. The processor(s) 106 can be semiconductor-based—that is, the processors can include semiconductor material that can perform digital logic. In some examples, the memory device(s) 108 may include a main memory that stores information in a format that can be read and/or executed by the processor(s) 106 to perform certain functions and/or execute certain modules (e.g., position calculator 114).

The central controller 104 may include a position calculator 114 configured to calculate a position 116 using the positional data 118 and kinematic structure data 110. In some examples, the position 116 is a 3D (live) position (e.g., 3D position map) of the user. In some examples, the kinematic structure data 110 includes a set of pre-programmed distance measurements of the user's body. In some examples, the kinematic structure data 110 is a model that defines the kinematic connectivity (e.g., structural and geometric priors) between keypoints, where the keypoints may include body parts that form a pose. In some examples, the keypoints include head, neck, right shoulder, left shoulder, right elbow, left elbow, right wrist, left wrist, right hip, left hip, right knee, left knee, right angle, and/or left ankle. Generally, the keypoints may refer to specific body parts or joints that form the pose. In some examples, the structure of the central controller 104, the controllers 126, and the sensor and feedback units 130 may cause the wearable motion capture device 102 to quickly calculate the position(s) 116 of the user in real-time or near real-time, in a manner that can adapt to the fast changing nature of VR/AR applications.

The central controller 104 may include a wireless transmitter 112 is configured to transmit (and receive) data from an external device such as the computing device 152 and/or the head-mounted display device 154. The head-mounted display device 154 may include an optical head-mounted display (OHMD) device, a transparent heads-up display (HUD) device, an augmented reality (AR) device, or other devices such as googles or headsets having sensors, display, and computing capabilities. In some examples, the wearable motion capture device 102 operates in conjunction with the head-mounted display device 154 to provide a fully immersive VR/AR experience. In some examples, the head-mounted display device 154 is a standalone computing system configured to execute one or more AR/VR applications. In some examples, the computing device 152 may include a laptop computer, desktop computer, smartphone, gaming console, or generally any type of computing device having a processor and memory and capabilities of wirelessly communicating with the central controller 104 over the network 150. In some examples, the computing device 152 is configured to execute an VR/AR application, which may operate with the head-mounted display device 154 and/or the wearable motion capture device 102.

The network 150 may include the Internet and/or other types of data networks, such as a local area network (LAN), a wide area network (WAN), a cellular network, satellite network, or other types of data networks. The network 150 may also include any number of computing devices (e.g., computer, servers, routers, network switches, etc.) that are configured to receive and/or transmit data within network 150.

In some examples, the wireless transmitter 112 is configured to transmit the position(s) 116, over the network 150, to the computing device 152 (or the head-mounted display device 154). In some examples, the computing device 152 may use the calculated position(s) 116 to more accurately reflect the user within the VR/AR environment. In some examples, instead of the position calculator 114 calculating the position(s) 116, the wireless transmitter 112 is configured to send the positional data 118 (e.g., captured by the units) to the computing device 152, where the computing device 152 computes the position(s) 116.

In some examples, the central controller 104 may include (or be associated with) an AI controller 120 configured to execute a neural network 122. Neural networks 122 transform an input, received by the input layer, transform it through a series of hidden layers, and produce an output via the output layer. Each layer is made up of a subset of the set of nodes. The nodes in hidden layers are fully connected to all nodes in the previous layer and provide their output to all nodes in the next layer. The nodes in a single layer function independently of each other (i.e., do not share connections). Nodes in the output provide the transformed input to the requesting process. In some examples, the neural network 122 is a convolutional neural network, which is a neural network that is not fully connected. Convolutional neural networks therefore have less complexity than fully connected neural networks. Convolutional neural networks can also make use of pooling or max-pooling to reduce the dimensionality (and hence complexity) of the data that flows through the neural network and thus this can reduce the level of computation required. This makes computation of the output in a convolutional neural network faster than in neural networks.

In some examples, the neural network 122 receives the positional data 118 and/or the calculated position(s) 116 as an input and outputs a gesture 124 of the user. In some examples, the neural network 122 is a classifier that can classify certain gestures 124 of the user based on the positional data 118 and/or the calculated position(s) 116. The gestures 124 may include any type of classified user gesture, such as moving one's finger, hand, the estimation of a step, or generally any type of movement, which can indicate a certain type of control within an AR/VR setting. In some examples, gestures 124 are not determined at the wearable motion capture device 102, but rather the positional data 118 and/or calculated position(s) 116 are transmitted to the computing device 152, which determines the gestures 124.

The wearable motion capture device 102 includes a power management module 132. The power management module 132 may include a battery 134 (or multiple batteries 134), and a battery charger 136. In some examples, the power management module 132 provides a system whereby individual cells are monitored (e.g., constantly monitored) by fuel gauges. In some examples, the power management module 132 may relay real-time battery usage and other metadata to the central controller 104, optimizing suit performance time and improving overall user experience. When charging, the power management module 132 is able to track battery performance statistics, and using historical battery data, battery end of life can be established.

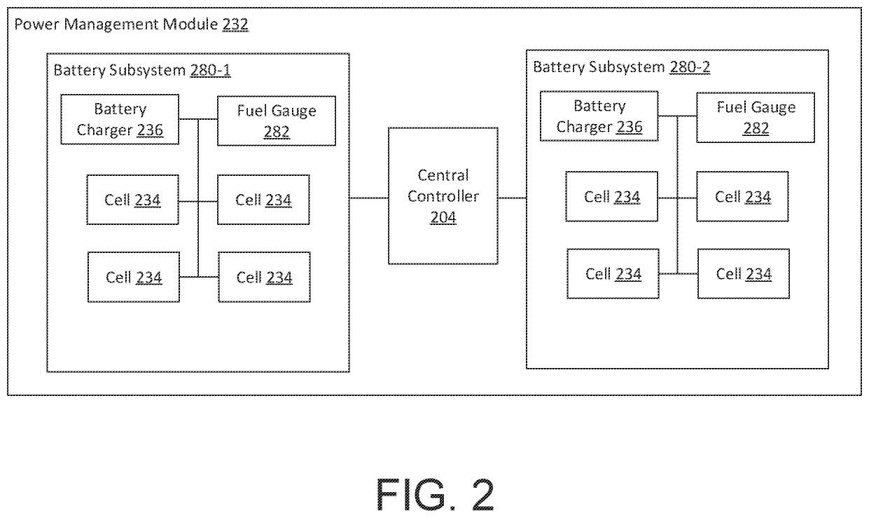

FIG. 2 illustrates a power management module 232 according to an aspect. The power management module 232 may be an example of the power management module 132 of FIGS. 1A through 1D and may include any of the details discussed with reference to those figures. The power management module 232 may include multiple battery subsystems, e.g., battery subsystem 280-1 and battery subsystem 280-2. Each of the battery subsystems may include a battery charger 236 connected to a fuel gauge 282 that monitors the level of charge within individual cells 234 associated with a particular subsystem. Each battery subsystem may report the level of charge associated with the individual cells 234 to a central controller 204. The central controller 204 may be an example of the central controller 104 of FIGS. 1A through 1D and may include any of the details discussed with reference to those figures.

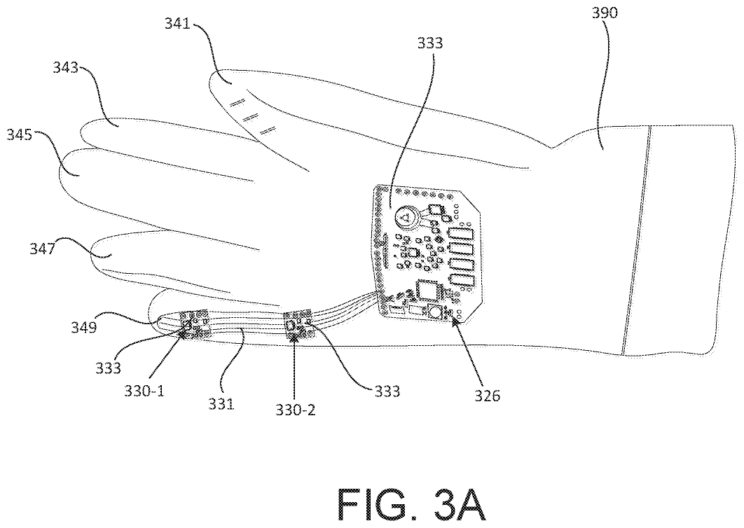

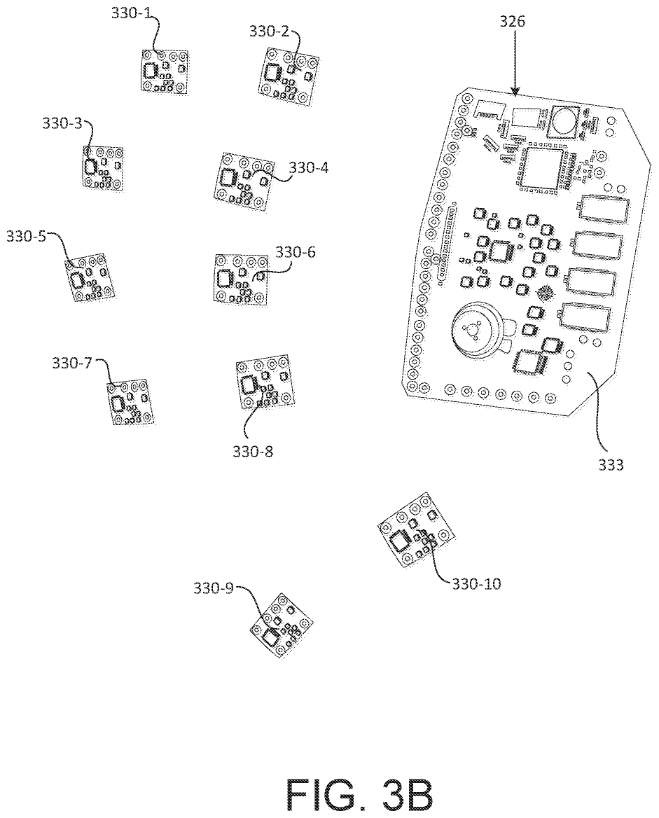

FIGS. 3A and 3B illustrate an example implementation of a portion of a wearable motion capture device with haptic feedback according to an aspect. FIG. 3A illustrates sensor and feedback unit 330-1 and sensor and feedback unit 330-2 coupled to a finger 349 of a glove 390. As shown in FIG. 3A, the sensor and feedback unit 330-1 and the sensor and feedback unit 330-2 are connected to a controller 326 via communication lines 331. FIG. 3B illustrates example components for a single glove 390. For example, sensor and feedback unit 330-3 and sensor and feedback unit 330-4 would be coupled to a finger 347, sensor and feedback unit 330-5 and sensor and feedback unit 330-6 would be coupled to a finger 345, sensor and feedback unit 330-7 and sensor and feedback unit 330-8 would be coupled to a finger 343, and sensor and feedback unit 330-9 and sensor and feedback unit 339-10 would be coupled to a finger 341 (thumb). In some examples, the same layout may be provided on the glove for the other hand. In addition, in some examples, as shown in FIG. 3A, the individual components of the controller 326 (and the individual units) may be coupled to a relatively thin (low weight) printed circuit board (PCB) 333, which can cause the wearable motion capture device 102 to be relatively light.

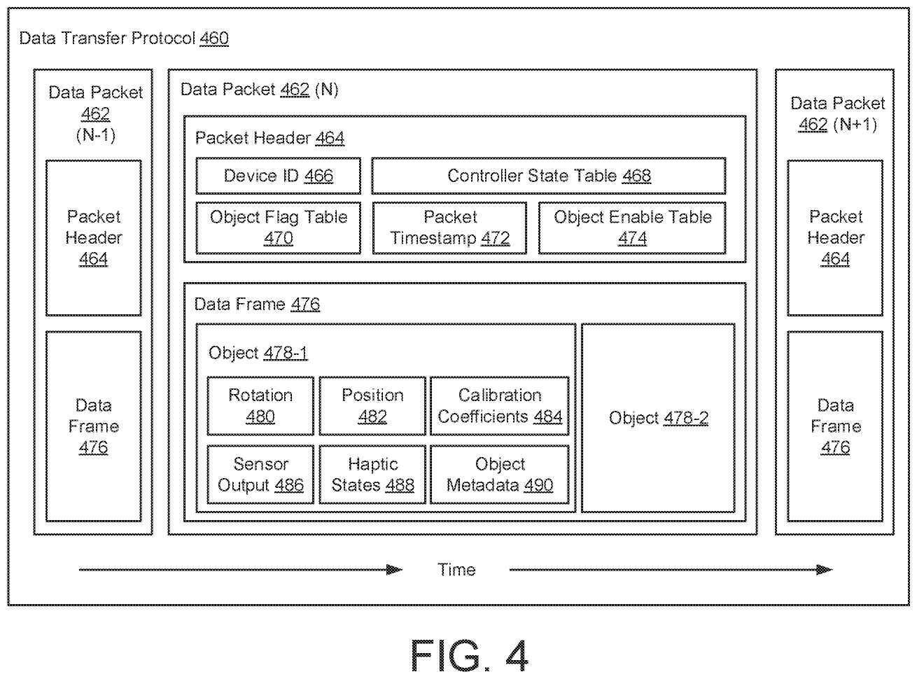

FIG. 4 illustrates a data transfer protocol 460 to transfer data on (or from) the wearable motion capture device 102 of FIGS. 1A through 1F (and/or any of the other embodiments discussed herein). Some parts of the data transfer protocol 460 are explained with reference to the wearable motion capture device 102 of FIGS. 1A through 1F. The data transfer protocol 460 may define a real-time data stream. In some examples, data is transmitted from the controllers 126 to the central controller 104 using the data transfer protocol 460. In some examples, data is transmitted from the central controller 104 to the computing device 152 using the data transfer protocol 460. As indicated above, the data collected from the sensor and feedback units 130 (e.g., the raw data) may be processed by the wearable motion capture device 102 or the computing device 152 (which can be a client computing device or a backend server) or a combination of one or more of these components. In some examples, the raw data may be transmitted to the central controller 104 using the data transfer protocol 460 and/or transmitted from the wearable motion capture device 102 to the computing device 152 using the data transfer protocol 460. The use of the data transfer protocol 460 may increase data transfer rates and provide higher fidelity output data.

Each controller 126 may transmit a series of data packets 462 over time (e.g., data packets N−1, N, N+1, etc.) to the central controller 104 (or from the wearable motion capture device 102 to the computing device 152). Each data packet 462 includes a packet header 464 and a data frame 476. Generally, the packet header 464 may include one or more portions of information about the overall state of the wearable motion capture device 102. The packet header 464 may include control data for the controllers 126 and the sensor and feedback units 130. The packet header 464 may include a device identifier 466. The device identifier 466 may identify a particular controller 126 that sends the information captured by the sensor and feedback units 130. The packet header 464 may include a controller state table 468. The controller state table 468 may include configuration parameters and/or information about the state of a particular controller 126. In some examples, the controller state table 468 includes the size and rate of data packets 462 that are reported by the controller 126. The controller state table 468 may also include information about specific settings within the controller, such as processor and/or memory usage, energy usage, and/or processor speed. The packet header 464 may include an object flag table 470. The object flag table 470 may include information on whether the controller 126 (or a portion thereof) is malfunctioning or not working, if individual position sensors 164 and/or haptic elements 162 are enabled, malfunctioning, or not working, and device-specific information, such as if data from specific sensors 164 and/or haptic elements 162 has updated. The packet header 464 includes a packet timestamp 472. The packet header 464 includes an object enable table 474, which could allow for individual position sensor 164 and/or haptic element 162 enable/disable functionality.

The data frame 476 includes one or more objects 478 such as object 478-1 and object 478-2. Each object 478 may relate to a separate sensor and feedback unit 130. For example, the object 478-1 includes information relating to the sensor and feedback unit 130-1, and the object 478-2 includes information relating to the sensor and feedback unit 130-2. Object 478-1 may include rotation 480 and/or position 482 detected by the sensor and feedback unit 130-1. The rotation 480 and the position 482 are used (in conjunction with all the other reporting sensor and feedback units 130) to track and detect the position of one or more body parts of the user (or the user as a whole). The positional data 118 of FIG. 1A may include the rotation 480 and/or the position 482. Object 478-1 may include calibration coefficients 484. The calibration coefficients 484 may include parameters associated with the sensor and feedback unit 130-1, where the parameters are used for determining whether the sensor and feedback unit 130-1 is properly calibrated (functioning). In some examples, the calibration coefficients 484 may include bias offsets and/or device self test output data. Based on the calibration coefficients 484, the central controller 104 may transmit configuration data to update the sensor and feedback unit 130 so that it is properly calibrated and/or transmit configuration data to deactivate the sensor and feedback unit 130 by way of the object enable table 474.

The object 478-1 may include sensor output 486. The sensor output 486 may include other sensor information collected by the sensor and feedback unit 130-1. The object 478-1 may include haptic states 488. The haptic states 488 provide information about the haptic element 162 included within a particular sensor and feedback unit 130, and could include the haptic element power level, and/or temperature, vibration, pressure, and/or other feedback information. The object 478-1 may include object metadata 490, where the object metadata 490 may include information on whether the sensor and feedback unit 130-1 is activated or deactivated. In some examples, the object metadata 490 may include unique device identifiers for the sensor and feedback units (e.g., sensor and feedback unit 130-1), and default and/or expected default states of the sensors and feedback units 130. In some examples, the object 478-2 includes the same information as described with reference to object 478-1.

For speed and precision, the size and rate of data packets 462 may be dynamically changed by the central controller 104. In some examples, the central controller 104 may automatically adjust the manner in which the sensor and feedback units 130 collect and report information back to the central controller 104. For example, the central controller 104 may deactivate one or more sensor and feedback units 130 for certain applications in response to a determination that the sensor and feedback units 130 are not needed to compute the position 116. The central controller 104 may transmit configuration data to the relevant controller 126, which then instructs the relevant sensor and feedback unit 130 to deactivate. In some examples, the central controller 104 may determine that a more accurate position 116 is required and may dynamically increase the rate at which data packets 462 are transmitted from the controller 126. For example, the central controller 104 may receive the data packet rate for a particular controller 126 via the controller state table 468 in the packet header 464. If the central controller 104 determines that a higher data packet rate is needed, the central controller 104 may transmit configuration data to the controller 126 to adjust its data packet rate.

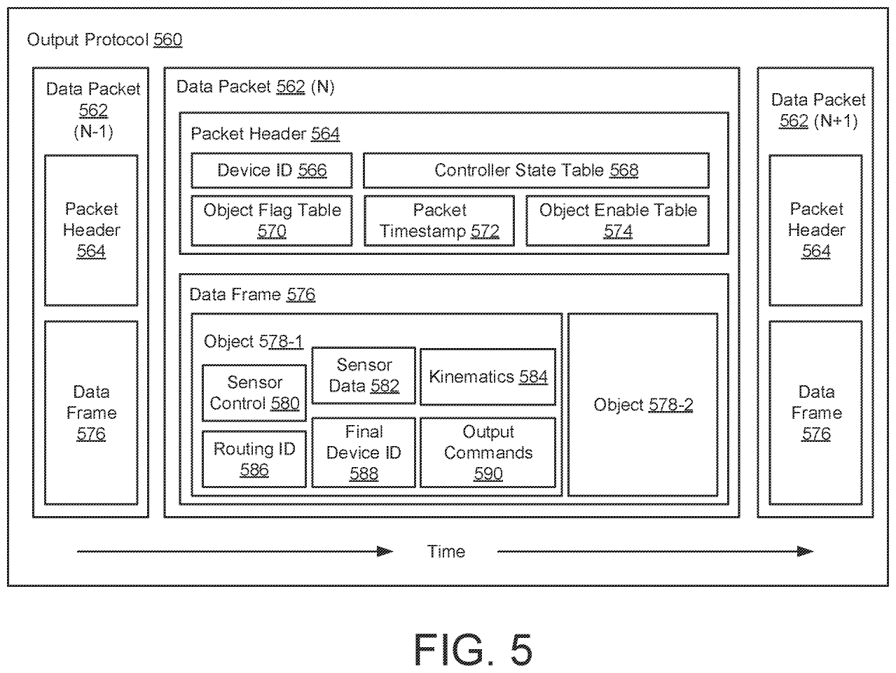

FIG. 5 illustrates an output protocol 560 to transfer data from the wearable motion capture device 102 to a device 151, a computing device 152, or a head-mounted display device 154. Some parts of the output protocol 560 are explained with reference to the wearable motion capture device 102, the head-mounted display device 154, the computing device 152, and the device(s) 151 of FIGS. 1A through 1F. The output protocol 560 may define a real-time data stream.

The central controller 104 (via an antenna) may transmit a series of data packets 462 over time (e.g., data packets N−1, N, N+1, etc.) to the computing device 152 or one or more devices 151. Each data packet 562 includes a packet header 564 and a data frame 576. In some examples, the packet header 564 includes the same type of information explained with reference to the packet header 464 of FIG. 4. In some examples, the packet header 564 is not the same as the packet header 464 of FIG. 4. The packet header 564 may include a device identifier 566, a controller state table 568, an object flag table 570, a packet timestamp 572, and an object enable table 574.

The data frame 576 includes one or more objects 578 such as object 578-1 and object 578-2. Each object 578 may relate to a specific device 151. For example, the object 578-1 includes information (e.g., device specific data) routed to a first device 151, and the object 578-2 includes information (e.g., device specific data) routed to a second device 151. The object 578-1 may include sensor control 580 (e.g., control commands that influence an aspect of an external device but that do not directly cause a visible change to the device), sensor data 582 (e.g. raw or mathematically manipulated data from the suit that could be useful for data processing on an external device 151), kinematics 584, a routing identifier 586, a final device identifier 588, and one or more output commands 590. The sensor data 585 may include any information collected by the sensor and feedback units 130 and/or the sensors 128 of FIG. 1A. The kinematics 584 may include any of the information described with reference to the kinematic structure data 110 of FIG. 1A. As such, in some examples, using this output format, the central controller 104 can route the information (e.g., positional data 118, other sensor data, kinematic structure data 110, etc.) to compute positions/gestures to outside devices. The output commands 590 may be commands that instruct a device 151 to perform a certain action. The routing identifier 586 may be the location in which the information of the object is routed (e.g., a web location, API, etc.). A final device identifier 588 may be the location of the corresponding external device 151 is located. In some examples, the object 578-2 includes the same information as described with reference to object 578-1.

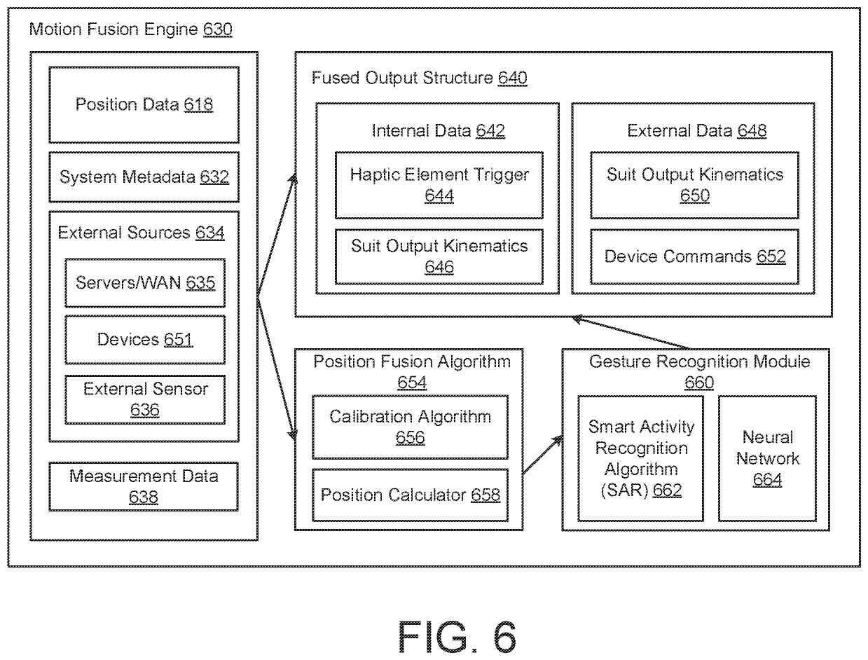

FIG. 6 illustrates a motion fusion engine 630 according to an aspect. The motion fusion engine 630 may be included as part of the central controller 104. The motion fusion engine 630 may receive and combine (e.g., fuse) data from a variety of different sources to compute a position of the user and/or recognize user gestures. For example, the motion fusion engine 630 may receive position data 618 (e.g., collected by the sensor and feedback units 130), system metadata 632, information from one or more external sources 634, and/or measurement data 638. The external sources 634 may include servers/WANs 635 (e.g., computing device 152 of FIG. 1A), devices 651 (e.g., devices 151 of FIG. 1A), and/or external sensors 636.

The motion fusion engine 630 may include a position fusion algorithm 654 having a calibration algorithm 656 and a position calculator 658. The position calculator 658 may be an example of the position calculator 114 of FIG. 1A. Using the position data 618, the system metadata 632, the measurement data 638, and/or the information from one or more external sources, the position calculator 658 may compute a position of the user. In some examples, the position is a 3D (live) position (e.g., 3D position map) of the user. The calibration algorithm 656 may perform one or more calibration operations on the position calculator 658.

The motion fusion engine 630 may include a gesture recognition module 660 configured to recognize a user gesture based on the detected positions. In some examples, the gesture recognition module 660 may include a smart activity recognition algorithm (SAR) 662. A SAR 662 is an algorithm that may, based on kinematic data from one or more position sensors 164 and a series of threshold values (e.g., measurement data 638), compute simple gestures and/or body orientations for output to the fused data structure 640. In some examples, the gesture recognition module 660 may include a neural network 664.

The motion fusion engine 630 may be configured to generate a fused output structure 640 of data that can be transmitted to one or more haptic elements 162 on the sensor and feedback units 130 of FIGS. 1A through 1F and/or to one or more devices 151 or computing devices 152. For example, the fused output structure 640 is a single unified output data, which was generated from a plurality of separate data streams. The fused output structure 640 may be in the form of an industry recognized motion capture standard, such as BVH (Biovision Hierarchy), MNM (Character Studio Marker Name File), and GMS (Gesture and Motion Signal) file formats. Also, the fused output structure 640 may also be received by one or more devices 151, e.g., integrated and/or processed onboard or by an external computing device over a network, and/or transferred to other computing devices or used to perform a task.

The fused output structure 640 may include internal data 642 that is routed to the sensor and feedback units 130. For example, the internal data 642 may include a haptic element trigger 644 that triggers the haptic elements 162. The internal data 642 may include suit output kinematics 646. The fused output structure 640 may include external data 648 that can be routed to a device 151. The external data 648 may include one or more device commands 652 configured to cause the device 151 to execute a function. The external data may include suit output kinematics 650.

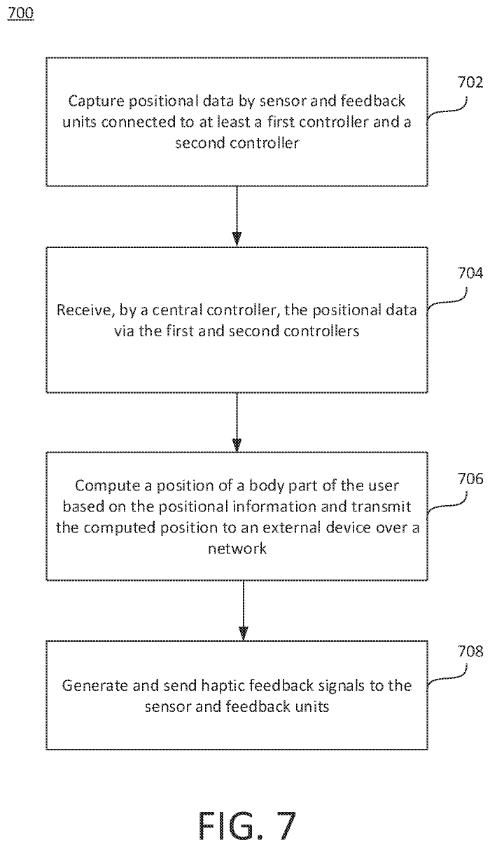

FIG. 7 is a flowchart 700 depicting example operations of the wearable motion capture device 102 of FIGS. 1A through 1D. Although the flowchart 700 of FIG. 7 illustrates the operations in sequential order, it will be appreciated that this is merely an example, and that additional or alternative operations may be included. Further, operations of FIG. 7 and related operations may be executed in a different order than that shown, or in a parallel or overlapping fashion.

Operation 702 includes capturing positional data by sensor and feedback units connected to at least a first controller and a second controller. Operation 704 includes receiving, by a central controller, the positional data via the first and second controllers. Operation 706 includes computing a position of a body part of the user based on the positional information and transmitting the computed position to an external device over a network. Operation 708 includes generating and sending haptic feedback signals to the sensor and feedback units.

The wearable motion capture device 102 may be used within a wide range of applications such as AR/VR education, healthcare/sports medicine, VR/AR gaming, occupational safety, military applications, as well as elder care/monitoring, emergency services, and/or workforce training. With respect to AR/VR education, the wearable motion capture device 102 may be used as an alternative to in-person learning. For example, the wearable motion capture device 102 in conjunction with a head-mounted display device 154 (e.g., virtual reality goggles) may provide a “virtual classroom” for students in their own homes. This may allow for an enhanced learning experience that immerses a user more fully than what is possible using some conventional techniques. With respect to healthcare/sports medicine, the combination of full body motion tracking, multifrequency GPS and AI pattern recognition would allow personal trainers and healthcare professionals to more accurately assess their patient's movement from any angle (including above and below) and prescribe longer lasting and more effective treatments.

With respect to VR/AR gaming, a dense sensor/feedback mesh network would allow for unprecedented control and deep immersion in a virtual game environment. As every aspect of a player's form is tracked and modeled, actions in game would appear extremely smooth and realistic. Also, haptic feedback would provide the player with an insight into what their character feels, be it something as light as a high five or as intense as a gunshot. With respect to occupational safety, the technology could be used as a training tool to prepare workers for new assignments, especially dangerous or critical jobs. It could also provide detailed body position information relative to fixtures and equipment for evaluating workplace injuries and designing better machines and processes. With respect to military applications, the technology could be implemented in situations where communicating an enormous quantity of data in a timely manner is mandatory. For example, by connecting the suit's haptic interface to the plane's onboard radar, a fighter pilot could “feel” other planes and objects in the surrounding airspace. As the haptic elements completely surround the wearer, a pilot would not be limited by their lack of 360° vision. Tactical units could use the technology to link individual members with each other and other data sources, for example a drone swarm flying above and around the unit as it advances on a target.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a LED (light emitting diode) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent exemplary functional relationships and/or physical or logical couplings between the various elements. Many alternative or additional functional relationships, physical connections or logical connections may be present in a practical device. Moreover, no item or component is essential to the practice of the embodiments disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

What is claimed is:

1. A wearable motion capture device comprising:
a central controller including a processor and memory device;
a plurality of controllers including a first controller and a second controller, each of the plurality of controllers configured to communicate with the central controller; and
a plurality of sensor and feedback units including a first group of sensor and feedback units and a second group of sensor and feedback units, the first group of sensor and feedback units configured to communicate with the first controller, the second group of sensor and feedback units configured to communicate with the second controller, each sensor and feedback unit including at least one of a position sensor and a haptic element, the position sensor configured to capture positional data about a position of a body part of a user,
wherein the central controller includes a position calculator configured to compute a position based on the positional data.

2. The wearable motion capture device of claim 1, further comprising:
a wireless transmitter configured to transmit the computed position to a computing device over a network.

3. The wearable motion capture device of claim 1, wherein the position sensor includes at least one of an accelerometer, a gyroscope, a motion processor, or a magnetometer.

4. The wearable motion capture device of claim 1, wherein the central controller is configured to generate a haptic feedback command and transmit the haptic feedback command to the first group of sensor and feedback units via the first controller.

5. The wearable motion capture device of claim 1, wherein the central controller is configured to recognize a user gesture based on computed positions.

6. The wearable motion capture device of claim 5, wherein, in response to the recognition of the user gesture, the central controller is configured to transmit a command, over a network, to a device, the command configured to cause the device to execute a function.

7. The wearable motion capture device of claim 1, wherein the central controller is configured to receive data, over a network, from one or more devices, the central controller is configured to use the data to trigger the haptic element.

8. The wearable motion capture device of claim 1, wherein the first group of sensor and feedback units is connected to the first controller via one or more first wired communication lines, the first controller is connected to the central controller via one or more second wired communication lines.

9. The wearable motion capture device of claim 8, wherein at least one of the first wired communication lines or the second wired communications include portions having angles greater than thirty-five degrees.

10. The wearable motion capture device of claim 1, wherein the first controller transmits the positional data captured by the first group of sensor and feedback units via a data transfer protocol, the data transfer protocol defining a series of data packets over time, each data packet including a packet header and a data frame, the data frame defining a first object corresponding to a first sensor and feedback unit and a second object corresponding to a second sensor and feedback unit, the first object including positional data captured by the first sensor and feedback unit, the second object including positional data captured by the second sensor and feedback unit.

11. The wearable motion capture device of claim 1, further comprising:
a first battery subsystem having a battery charger and a fuel gauge; and
a second battery subsystem having a battery charger and a fuel gauge,
wherein the central controller is connected to the first battery subsystem and the second battery subsystem.

12. A method comprising:
detecting first positional data by a first group of sensor and feedback units connected to a first controller;
detecting second positional data by a second group of sensor and feedback units connected to a second controller;
transmitting, by the first controller, the first positional data to a central controller;
transmitting, by the second controller, the second positional data to the central controller;
computing, by the central controller, a position of at least a body part of a user of a wearable motion capture device based on, at least in part, the first and second positional data;
transmitting, over a network and by the central controller, the computed position to a computing device; and
transmitting, by the central controller, one or more haptic feedback signals to at least one of the first group of sensor and feedback units or the second group of sensor and feedback units.

13. The method of claim 12, further comprising:
recognizing a user gesture based on computed positions; and
in response to the recognition of the user gesture, transmitting a command, over the network, to a device, the command configured to cause the device to execute a function.

14. The method of claim 12, further comprising:
receiving data, over the network, from one or more devices; and
in response to receiving the data, transmitting, by the central controller, one or more haptic feedback signals to at least one of the first group of sensor and feedback units or the second group of sensor and feedback units.

15. The method of claim 12, wherein the first group of sensor and feedback units is connected to the first controller via one or more first wired communication lines, the first controller is connected to the central controller via one or more second wired communication lines.

16. The method of claim 12, wherein the positional data captured by the first group of sensor and feedback units is transmitted via a data transfer protocol, the data transfer protocol defining a series of data packets over time, each data packet including a packet header and a data frame, the data frame defining a first object corresponding to a first sensor and feedback unit and a second object corresponding to a second sensor and feedback unit, the first object including positional data captured by the first sensor and feedback unit, the second object including positional data captured by the second sensor and feedback unit.

17. A non-transitory computer-readable medium storing executable instructions that when executed by at least one processor cause the at least one processor to execute operations, the operations comprising:
receive, by a first controller, first positional data from a first group of sensor and feedback units connected to the first controller;
receive, by a second controller, second positional data from a second group of sensor and feedback units connected to the second controller;
transmit, by the first controller, the first positional data to a central controller via data transfer protocol;
transmit, by the second controller, the second positional data to the central controller via the data transfer protocol;
compute, by the central controller, a position of at least a body part of a user of a wearable motion capture device based on, at least in part, the first and second positional data; and
transmit, by the central controller, one or more haptic feedback signals to at least one of the first group of sensor and feedback units or the second group of sensor and feedback units.

18. The non-transitory computer-readable medium of claim 17, wherein the data transfer protocol defines a series of data packets over time, each data packet including a packet header and a data frame, the data frame defining a first object corresponding to a first sensor and feedback unit and a second object corresponding to a second sensor and feedback unit, the first object including positional data captured by the first sensor and feedback unit, the second object including positional data captured by the second sensor and feedback unit.

19. The non-transitory computer-readable medium of claim 17, the operations further comprising:
recognize a user gesture based on computed positions; and
in response to the recognition of the user gesture, transmit a command, over a network, to a device, the command configured to cause the device to execute a function.

20. The non-transitory computer-readable medium of claim 17, the operations further comprising:
receive data, over a network, from one or more devices; and
in response to receipt of the data, transmit, by the central controller, one or more haptic feedback signals to at least one of the first group of sensor and feedback units or the second group of sensor and feedback units.
